(19) United States
(12) Patent Application Publication
(10) Pub. No.: US 2011/0197166 A1
(43) Pub. Date: Aug. 11, 2011

(54) METHOD FOR RECOMMENDING ENTERPRISE DOCUMENTS AND DIRECTORIES BASED ON ACCESS LOGS

(75) Inventors: Andreas Girgensohn, Palo Alto, CA (US); Frank Shipman, College Station, TX (US); Lynn Wilcox, Palo Alto, CA (US)

(73) Assignee: FUJI XEROX CO., LTD., Tokyo (JP)

(21) Appl. No.: 12/701,466

(22) Filed: Feb. 5, 2010

(51) Int. Cl. G06F 17/30; G06F 3/048

(52) U.S. Cl. 715/846; 707/751; 707/E17.009

(57) ABSTRACT

Systems and methods recommend documents or directories in an enterprise context by analyzing use proximity in the organizational hierarchy to find similar users. Evidence may be used from different sources to gage the degree of interest a user may have in a document. Such pieces of evidence may include viewing page thumbnails, viewing the document online, or printing, saving, or bookmarking the document. To make managing these different sources of evidence from users related by different degrees tractable, a model may be created where evidence values decay by different amounts over time and are combined with different weights. Additionally, these systems and methods also can make use of the directory structure of the document space to recommend directories as well as individual documents.

### BACKGROUND

1. Field of the Invention

This invention generally relates to systems for recommending documents and more specifically to systems for recommending documents and directories based on access logs.

2. Description of the Related Art

Recommender systems are useful in many contexts and have become common tools for people finding movies, books, etc. Thus, it is natural to apply recommender techniques to the enterprise context. Unfortunately, most recommender techniques are not directly applicable due to assumptions about information availability and access homogeneity. Typically, recommender techniques rely on individuals having access to the same set of resources. In a corporate context, each employee is likely to have access to a different subset of resources. This may undermine some of the statistical analysis techniques commonly used. These systems also rely on users being willing to share evaluations of resources and interests. Such information is unlikely to be available in the enterprise context. The enterprise social setting makes it inappropriate for employees to rate each other's (or their boss's) documents. Likewise, issues of privacy and compartmentalization make it unlikely to centralize information that can be used to determine who is working on what.

Therefore, there is a need for a solution for creating a recommender system suitable for the enterprise or corporate context.

### SUMMARY

Aspects of the present invention include a system which may include a display, a storage system, an organizational table with organizational attributes of users of the system, a recommendation unit and a scoring unit. The scoring unit may generate a score for a document for a requesting user by identifying organizational attributes of a user who previously interacted with the document, analyzing a relationship between the organizational attributes of the user who interacted with the document and the organizational attributes of the requesting user, and assigning a score to the document based on the analyzed relationship between the organizational attributes of the user who accessed the document and the organizational attributes of the requesting user. The recommendation unit may recommend the document to the requesting user if the score assigned to the document exceeds a threshold value, by displaying the document to the requesting user on the display.

Aspects of the present invention further include a system which may include a display, a storage system, a scoring unit assigning a score to a directory, and a recommendation unit recommending the scored directory to a user.

Aspects of the present invention further include a system which may include a display, a storage system, a scoring unit assigning a score to a document based on an interaction history of the document; and a recommendation unit recommending the scored document to a user. The score of the document may be decayed over time

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an example plot of a decayed evidence score with multiple interactions according to an embodiment of the invention.

FIG. 2 illustrates a plot combining short-term and long-term evidence with different weights according to an embodiment of the invention.

FIG. 3 illustrates an example display of an implementation within a document browsing system according to an embodiment of the invention.

FIG. 4 illustrates an example flow chart for one of the embodiments of the invention.

FIG. 5 illustrates an example functional diagram according to one of the embodiments of the invention.

FIG. 6 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

Given the lack of explicit ratings and issues that come up due to access control, designing mechanisms or systems to generate suggestions requires an understanding of the structure of activity within an enterprise. Thus, it may be necessary to look at different properties of corporate organizations. Once appropriate recommender groups have been identified, embodiments of such systems base the recommendations on recency (how recently a document has been accessed) and the type of access (i.e. viewing, printing, saving, etc.). Document similarity could also be considered. During searches, recommendations can be filtered by Boolean searches and re-ranked by searches with floating point scores. Embodiments of the system can then present recommendations and indicate the basis for each recommendation.

Defining Recommender Groups in a Corporate Setting

The hierarchic structures of organizations are meant to limit the need for information flow between parts of the organization. As a result, only very general documents such as phone lists, policy descriptions, and guidelines are likely to be widely available across an organization. This raises the problem of identifying activity in the organization's information access that is predictive of future needs of an individual.

Instead of using interaction history of the whole user community to recognize people with similar information needs, as is generally true in traditional recommender algorithms, it may be better to use subgroups of the organization chosen based on an understanding of information access in organizations and organizational attributes that reflect on the subgroups. These organizational attributes could then be stored in a table for reference. For example, two organizational attributes of individuals that can be used to identify subgroups are:

Organizational Structure.

The information needs of people in the same part of the organization are likely to be indicative of the needs of others in that part of the organization. The first subgroup considered are those individuals who are part of the same organizational component. Determination of the organizational levels used for this grouping requires knowledge of the organization.

Job Classification.

The organizational structure is not the only hierarchic decomposition of an enterprise. A classification indicative of the type of activity one is involved in is one's job title and different types of activities (e.g. accounting, purchasing, administration, etc.). Thus, a second subgroup used to generate suggestions is the set of people with the same or similar job title. Again, some knowledge of the organization is required to determine which job titles (e.g. assistant professor, associate professor, professor) should be combined into a single group. Thus, analysis based on hierarchical relationships can be conducted.

To generate suggestions based on each of these groups, individual access histories are aggregated into relevance scores as described below. Thus, all of the individuals in a specified organizational layer are included in organizational structure recommendations. If a complete organizational structure is available, the individual assessments can be weighted by distance from the individual accessing the document store. Otherwise, all individuals within that structure are equally weighted. Similarly, all individuals within the set of job titles defined as equivalent for this purpose are included for generating job classification recommendations.

A final change with regard to traditional recommender algorithms is that suggestions can be for directories as well as individual documents. Directories are important in organizations as the location where documents in a particular sequence are kept. Thus, while past interactions with the January, February, and March accounting files for an office would not point to the April accounting file in a traditional recommender approach, certain embodiments of the present invention will point to the directory that includes the April file.

Computing Document Value Based on Interaction

There are two main reasons to suggest a directory. First, when a significant fraction of documents in a directory would be suggested, it is more efficient to suggest the whole directory so that additional suggestions in other portions of the document store can also be suggested. Second, patterns of behavior may bring users back to the same directory over and over again but for different files. This is the case for directories where work practices result in the periodic use of new files (e.g. monthly reports, budgets, etc). Computing the interest value of a directory can be based on the interest of the files and subdirectories within that directory, as well as the history of interaction with that directory in the log.

Document values are computed based on a variety of evidence of user interest in the document. This evidence includes viewing page thumbnails, viewing the document online, or printing, saving, or bookmarking it. Other interactions may also serve as evidence of user interest, such as creation of the document, renaming the document, editing, etc. To compute the likely interest value of a document for a particular individual, a model is used to incorporate evidence from the type and history of document interaction and access by that individual and members of that individual's work group. For each form of evidence, an evidence value is computed based on the history of document interaction. Evidence generated by such multiple forms is combined as a weighted sum. The weights are determined by the relationship between the user creating the evidence and the user receiving the recommendations. For example, previous visits by the user receiving the recommendation may carry more weight than a visit by the boss and that in turn may carry more weight than a visit by a colleague in another group.

In computing value of a document based on interaction, not only the number of visits is taken into account, but also the recency of these visits. This allows adaptation of values over time. However, storing all interactions by all users for each document may be too inefficient. Instead, a framework can be established for storing a single record for each type of interaction a user had with a document. Evidence may diminish over time and multiple visits may produce less evidence than the sum of evidence produced by individual visits.

In one embodiment of the system, exponential decay can be used to represent the diminishing evidence. For each form of evidence, i.e., each form of document interaction considered valuable for determining the document value, the system can compute an evidence value based on a particular initial value of the evidence type (interactions indicating stronger interest receive initial evidence values) and a half life of the evidence type (some interactions may indicate short-term interest while others may indicate longer-term interest). To provide a recommendation at the time tᵣ, the evidence of interactions at times tᵢ is decayed and summed up.

$${e}_{r} = {\sum }_{i} {0.5}^{\frac{{t}_{r} - {t}_{i}}{h}} \qquad ( Eq . 1 )$$

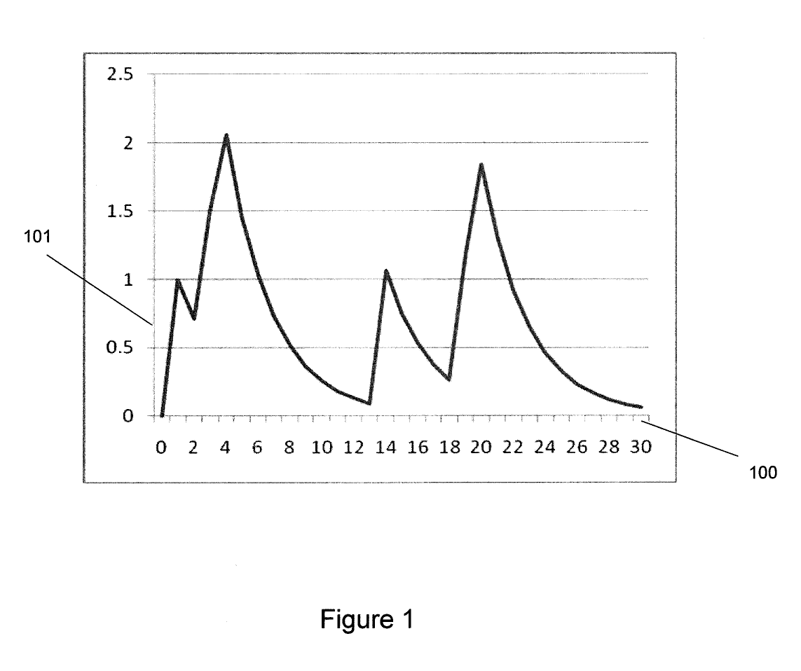

FIG. 1 illustrates an example plot of decayed evidence score with multiple interactions according to an embodiment of the invention. The evidence for a particular type of interaction eᵣ at time tᵣ is the sum of interactions that occurred at all previous times tᵢ decayed by the half life h as indicated by Equation 1. In the example illustrated in FIG. 1, the horizontal-axis, or x-axis, 100 represents a period of time tᵣ for a document, and the vertical axis, or y-axis, 101 represents the sum of previous interactions.

However, the system does not have to store all times tᵢ; the most recent time with the evidence score at that time may suffice. An evidence score computed at time tᵣ can be transformed to one at time tₛ using the following formula, shown in Equation 2, assuming that no new interactions have taken place between tᵣ and tₛ:

$${e}_{s} = {0.5}^{\frac{{t}_{s} - {t}_{r}}{h}} \cdot {e}_{r} \qquad ( Eq . 2 )$$

Every time a new user interaction at time tₙ, takes place, the previous score eₙ₋₁ representing interactions up to the time tₙ₋₁ is transformed to the new time and then 1 is added. The new score eₙ and the new time tₙ are stored in the database. The database then remains unchanged until a new user interaction takes place. Evidence values eᵣ at later times tᵣ are computed from the stored values (see Eq. 3).

$${e}_{n} = {0.5}^{\frac{{t}_{n} - {t}_{n}}{h}} + {\sum }_{i}^{n - 1} {0.5}^{\frac{{t}_{n} - {t}_{i}}{h}} = 1 + {0.5}^{\frac{{t}_{n} - {t}_{n - 1}}{h}} \cdot {e}_{n - 1} \qquad ( Eq . 3 )$$

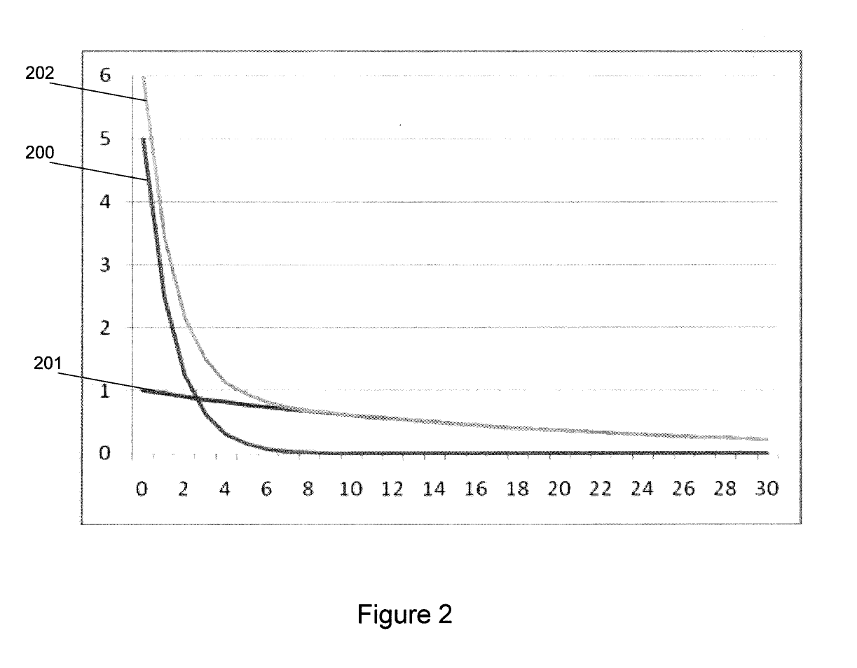

FIG. 2 illustrates a plot combining short-term and long-term evidence with different weights according to an embodiment of the invention. As in FIG. 1, the horizontal-axis, or x-axis, represents a period of time over which this example document was observed, and the vertical-axis, or y-axis, represents the sum of previous interactions. To generate recommendations that are based on a user's current task and also recommendations based on long-term patterns of activity, each evidence type generates long-term and short-term document value terms. The short-term evidence term 200 has a high initial value and a short half life so that its effect decays rapidly (e.g. lasting on the order of days). The long-term evidence term 201 has a low initial value but a long half life so it aggregates over long periods (e.g. lasting on the order of months). FIG. 2 shows how short term evidence with a weight of 5 is combined with long-term evidence with a weight of 1 and the resulting sum 202. Instead of summing up evidence at two time scales, one could also use the maximum. However, that would produce a less smooth curve.

Additionally, each document could have an independent group evidence term used to make group-activity-based recommendations. This term could have a low initial value and a long half life, similar to the long-term evidence term for personalized recommendations. Indeed, these two terms could be the same.

As an example, an embodiment of the system can be used to distinguish between documents that have been viewed in the interactive tool tip and those that were opened in the document viewer. The former can be considered to be a quick glance and the latter can be considered to be a more detailed exploration. In this case, the glance in the tool tip is given a lower initial evidence value and a shorter half life than the opening of the document in the document viewer. Additional evidence could be derived from page views and navigation events within a document. For example, a study by Badi et al. (2006) indicated that of the forms of user interaction with documents in a browser, scrolling up through a document has a greater correlation to perceived document value (R. Badi, S. Bae, J. M. Moore, K. Meintanis, A. Zacchi, H. Hsieh, C. Marshall, F. Shipman, “Recognizing User Interest and Document Value from Reading and Organizing Activities in Document Triage”, Proceedings of ACM Intelligent User Interfaces, 2006, pp. 218-225). Evidence for each form of interaction is accumulated per individual user in the system.

Instead of just counting events that produce evidence, embodiments of the system could also record the length of time a user spends with a document. This could be incorporated into the described model by sampling at regular intervals and counting a document viewed for a long time as multiple visits.

Computing Directory Value

There are two main reasons to suggest a directory. First, when a significant fraction of documents in a directory would be suggested, it is more efficient to suggest the whole directory so that additional suggestions in other portions of the document store can also be suggested. Second, patterns of behavior may bring users back to the same directory over and over again but for different files. This is the case for directories where work practices result in the periodic use of new files (e.g. monthly reports, budgets, etc). Computing the interest value of a directory is based on the interest of the files and subdirectories within that directory, as well as the history of interaction with that directory in the log.

Especially when considering the first reason, one could compute the directory interest value using the approach described here for determining directory match scores for search results. In that approach, the score for a directory tree combines the score of the best-matching document with the total number of matching documents and the density of the match scores. A match score for a directory is given by Equation 4:

$$s = b \cdot \sqrt{\frac{{d}^{2} + {c}^{2}}{2}} \qquad ( Eq . 4 )$$

where b is the best match score among documents in the directory tree, d is the normalized density, and c is the normalized count. The density is the average match score, including documents with a match score of zero. The count is the number of documents with a non-zero match score. Both d and c are normalized relative to the greatest value from the subdirectories being compared. For combining d and c, the quadratic mean can be chosen because it comes close to picking the maximum of the two values without completely ignoring the other value. For the recommender system, one can just replace the search match score with the interest value for each document.

While such a score can be used to determine which directories to recommend more than others, it does not fully address the question whether to recommend a directory instead of the contained documents and where to place the directory in an ordered list of other recommended documents. As an alternative, two metrics for a directory are examined. The first is aimed at making the visualization efficient. For this, the metric is taken to be the maximum of the percentage of the documents in a directory that are being suggested and the percentage of suggested documents coming from the directory in question, as shown in Equation 5.

Directory_metric_{—}1=max(# files in directory suggested/# of files in directory, # files in directory suggested/# of files suggested) (Eq. 5)

The second metric for computing a directory's value is based on the log of interaction with that directory in the interface and an aggregation of the value of its constituent files and subdirectories, as shown in Equation 6.

Directory_metric_{—}2=f(activity on directory)+weighted_sum(subdirectory_values)+weighted_sum(local_document_values) (Eq. 6)

To compute the second directory metric without causing the top-level directory to always have the highest directory value requires that the terms based on activity in subdirectories be weighted less than the activity in the directory. One possible instantiation is to divide by a function of the navigation distance between the parent directory and the subdirectory (e.g. the distance itself or the square of the distance) to reduce the effect of evidence far down the directory tree. When considering that subdirectories can only be reached through their parent directories, one can also use negative weights for the sum of subdirectory values such that when the final score is tallied, the sum of the subdirectory values will be negative. This would have the effect that only the directory where the user stops would have a high interest value.

To determine which of these approaches is most appropriate for a particular access pattern to a corporate repository (and to find good weights for weighted sums), logs of document access in the repository can be used to compare the results for different approaches. While accessing the complete log is inefficient for computing recommendations, it is a good means to tune the recommendation algorithms in an offline fashion.

During a search, only documents matching Boolean search terms are presented as recommendations to the user. For searches returning floating point scores such as text searches, the document interest value is adjusted by the strength of the match to the search query. Unlike Boolean searches where a document either matches or not, floating point scores indicate the quality of the match. In text searches, such a score can be determined by the product between term frequency and inverse document frequency to return higher scores for documents that contain a search term multiple times. Because documents with lower scores should not just be removed from consideration, embodiments of the invention adjust the recommendation score instead so that documents with poor matches to the search query also get low recommendation scores.

Presenting Suggestions within a Document Browsing System

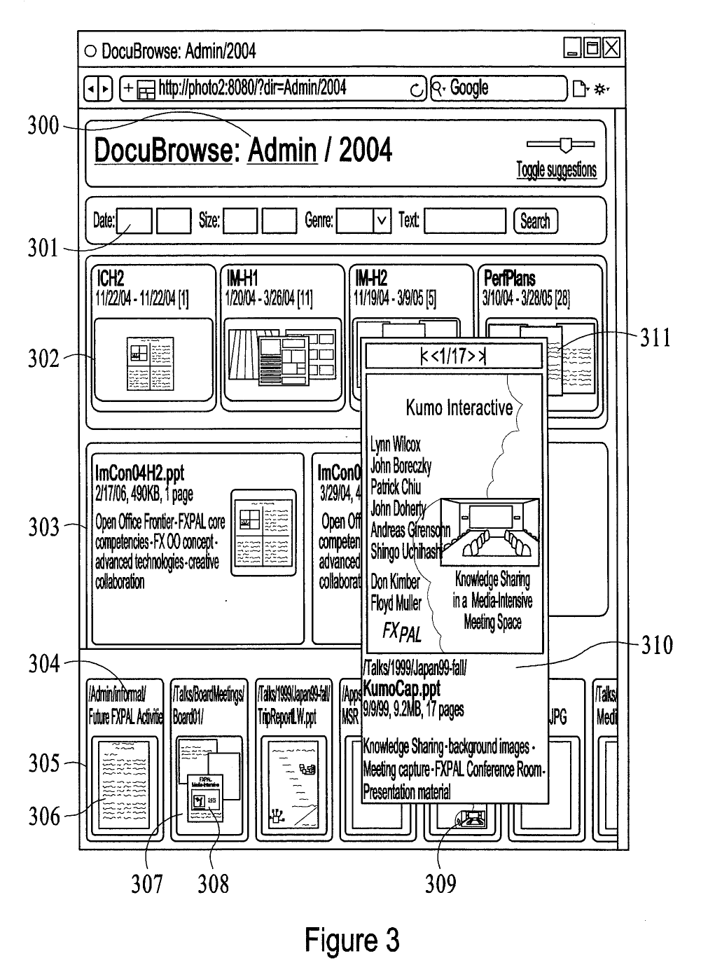

FIG. 3 illustrates an example implementation within a document browsing system according to an embodiment of the invention. In this implementation, the features within the document browsing system include displaying the currently browsed directory 300, an input field for searching 301, listings of subdirectories of the current directory 302 and listings of documents in the current directory 303. Thumbnails of select documents within the subdirectories can also be displayed 311.

One embodiment of the recommendation system can thus be integrated within such a document browsing system by displaying, for example, the path to recommended directories/documents 304 inside a recommendation pane 305. The recommendation pane can include document recommendations 306 or directory recommendations with select thumbnails 307. In this example of the directory recommendation, the three most relevant documents are shown within the thumbnail, with the most relevant document in the front 308.

Because multiple methods are used to generate suggestions, the document browsing system can expose the form of reasoning used to generate each suggestion (through color coding or other means). For example, the document browsing system can indicate categories of suggestions such as suggestions based on personal interaction history, suggestions based on the interaction history of members of one's organizational branch, suggestions based on the interaction history of employees with similar job titles, suggestions based on multiple lines of reasoning, and so forth.

However, users of the system do not necessarily need to know the specifics of the reasoning approaches. It is natural that some forms of reasoning are more valuable for some jobs than others. Experimenting with different examining suggestions (i.e. with different color codings or other means) will lead users to learn which classes of suggestions work best for them.

As users filter the display of the document space via metadata and search, the filters are also applied to the suggestions. Thus, the suggestions can be made relevant to the user's currently expressed information need.

Other methods can be used instead of displaying suggestions in the floating pane. For example, the suggestions can also be associated with the corresponding subdirectory in the document browsing system's directory display. For example, the system can replace the document thumbnails representing directories that are selected such that they are distributed evenly across the directory tree. Documents with the highest interest value can also be used to represent the directory that contains them. The system can also make the directory boxes wider and display the recommended document thumbnails on the side, or display the recommended document thumbnails in the popup tool tip when the user moves the mouse cursor 309 over a directory box, as shown in popup tool tip 310 in FIG. 3. Furthermore, not every document scored needs to be recommended; a threshold can be used to filter out low scoring documents so that documents of little value won't be recommended to the user.

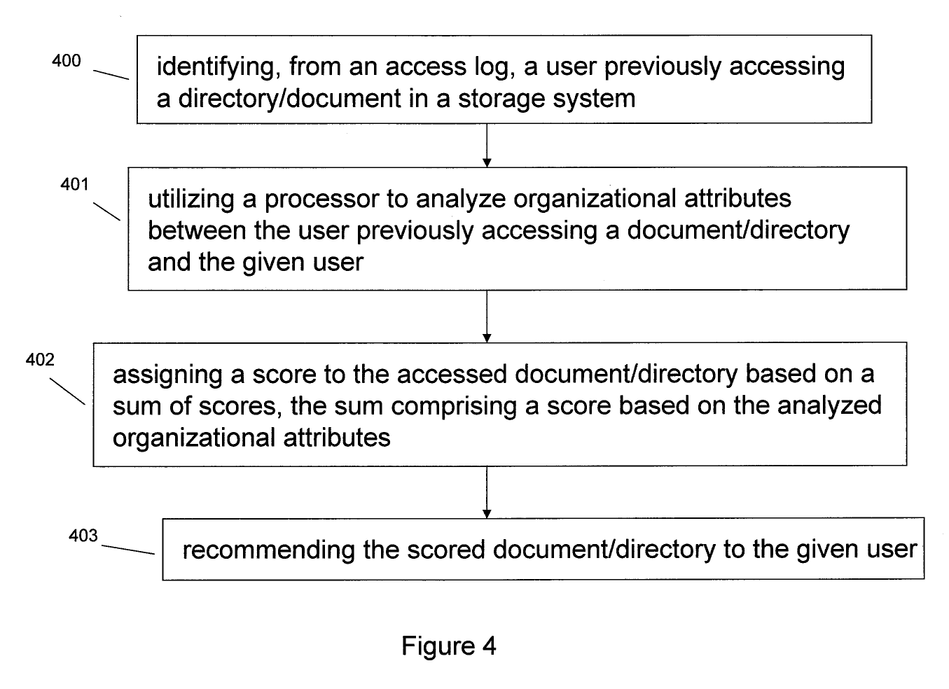

FIG. 4 illustrates an example flow chart for one of the embodiments of the invention for recommending a directory or a document to a given user. First, the system will identify, from an access log, a user previously accessing a directory/document in a storage system 400. Subsequently, a processor is utilized to analyze organizational attributes between the user previously accessing the identified document/directory and the given user 401. Then a score is assigned to the accessed document/directory based on a sum of scores, the sum comprising a score based on the analyzed organizational relationship and a score based on the analyzed hierarchical relationship 402. As not all documents/directories are necessarily scored, scored document/directories are then recommended to the given user 403. The recommendation can be conducted, for example, by showing the user recommended documents from highest scored to lowest scored in thumbnail form.

The access log does not need to be traversed entirely, because embodiments of the system can store the score and date for each document access triplet of document, user, and type of access (e.g., printing, saving) recorded within the access log. Only triples with non-zero values are stored. Each of these triplets can have an associated decay rate and weighting factor. To determine recommendations, first all users related to the user receiving the recommendations are determined. For all those users, all of their respective document-access triples are retrieved. Then, the values are decayed as appropriate for the time passed since the last access, and multiplied with the weighting factor. For each document, those computed values are added up and the scored documents are recommended. As mentioned previously, not all scored documents need to be recommended; a threshold can be used to filter out low scoring documents so that documents of little value won't be recommended to the user

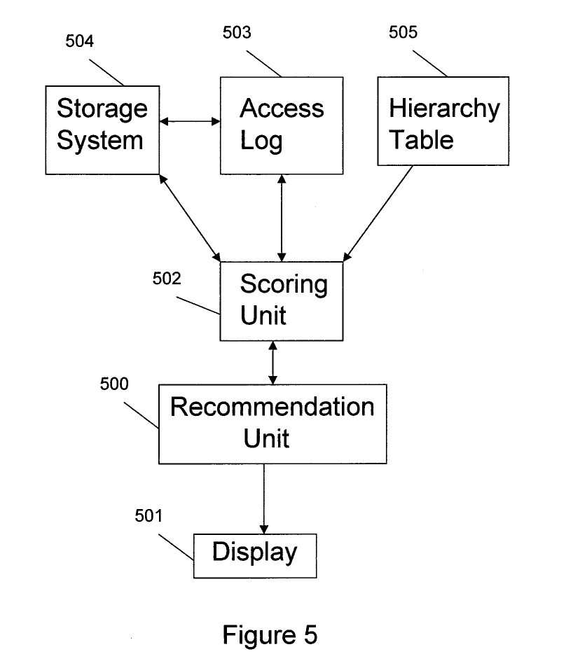

FIG. 5 illustrates an example functional diagram according to one of the embodiments of the invention. A recommendation unit 500 recommends a document or a directory to a given user by displaying the recommendations on a display 501. The recommendations are made based on a score assigned to a document or a directory by a scoring unit 502. The scoring unit will reference an access log 503 to look for previously accessed documents and directories in the storage system 504, and to determine the user who accessed the document/directory. The scoring unit will also analyze the organizational and hierarchical relationship between the given user and the user who accessed the document/directory by referencing a hierarchy table 505. Documents and directories that are scored are fed to the recommendation unit, which can then display the recommendations to the given user.

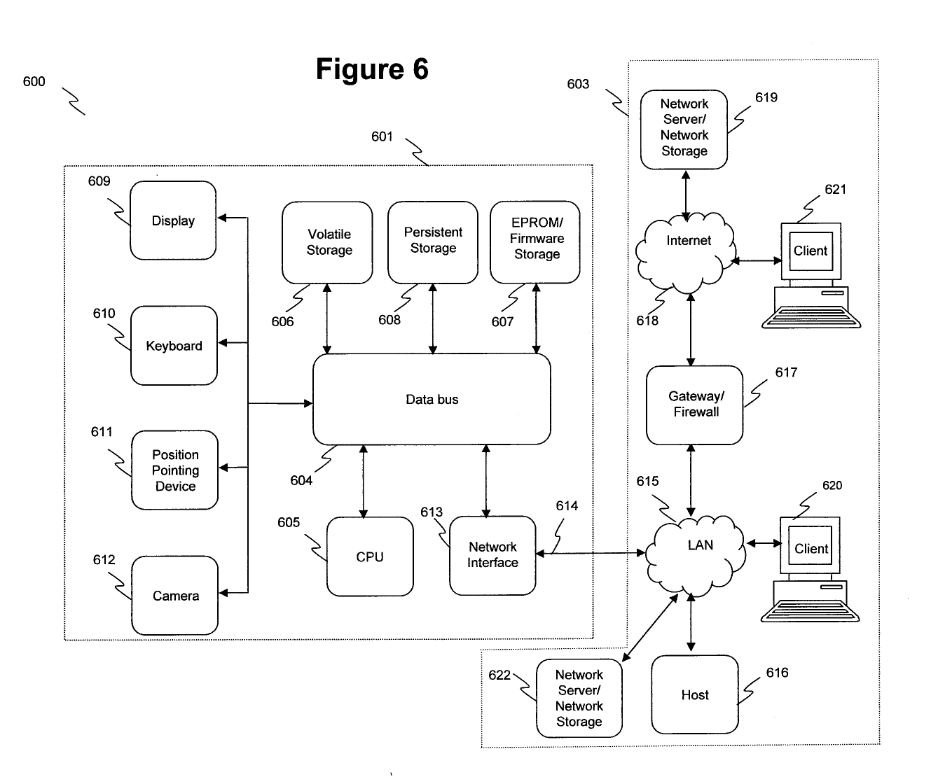

FIG. 6 is a block diagram that illustrates an embodiment of a computer/server system 600 upon which an embodiment of the inventive methodology may be implemented. The system 600 includes a computer/server platform 601, peripheral devices 602 and network resources 603.

The computer platform 601 may include a data bus 604 or other communication mechanism for communicating information across and among various parts of the computer platform 601, and a processor 605 coupled with bus 601 for processing information and performing other computational and control tasks. Computer platform 601 also includes a volatile storage 606, such as a random access memory (RAM) or other dynamic storage device, coupled to bus 604 for storing various information as well as instructions to be executed by processor 605. The volatile storage 606 also may be used for storing temporary variables or other intermediate information during execution of instructions by processor 605. Computer platform 601 may further include a read only memory (ROM or EPROM) 607 or other static storage device coupled to bus 604 for storing static information and instructions for processor 605, such as basic input-output system (BIOS), as well as various system configuration parameters. A persistent storage device 608, such as a magnetic disk, optical disk, or solid-state flash memory device is provided and coupled to bus 601 for storing information and instructions.

Computer platform 601 may be coupled via bus 604 to a display 609, such as a cathode ray tube (CRT), plasma display, or a liquid crystal display (LCD), for displaying information to a system administrator or user of the computer platform 601. An input device 610, including alphanumeric and other keys, is coupled to bus 601 for communicating information and command selections to processor 605. Another type of user input device is cursor control device 611, such as a mouse, a trackball, or cursor direction keys for communicating direction information and command selections to processor 604 and for controlling cursor movement on display 609. This input device typically has two degrees of freedom in two axes, a first axis (e.g., x) and a second axis (e.g., y), that allows the device to specify positions in a plane.

An external storage device 612 may be coupled to the computer platform 601 via bus 604 to provide an extra or removable storage capacity for the computer platform 601. In an embodiment of the computer system 600, the external removable storage device 612 may be used to facilitate exchange of data with other computer systems.

The invention is related to the use of computer system 600 for implementing the techniques described herein. In an embodiment, the inventive system may reside on a machine such as computer platform 601. According to one embodiment of the invention, the techniques described herein are performed by computer system 600 in response to processor 605 executing one or more sequences of one or more instructions contained in the volatile memory 606. Such instructions may be read into volatile memory 606 from another computer-readable medium, such as persistent storage device 608. Execution of the sequences of instructions contained in the volatile memory 606 causes processor 605 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 605 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 608. Volatile media includes dynamic memory, such as volatile storage 606. Transmission media includes coaxial cables, copper wire and fiber optics, including the wires that comprise data bus 604. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 605 for execution. For example, the instructions may initially be carried on a magnetic disk from a remote computer. Alternatively, a remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on the data bus 604. The bus 604 carries the data to the volatile storage 606, from which processor 605 retrieves and executes the instructions. The instructions received by the volatile memory 606 may optionally be stored on persistent storage device 608 either before or after execution by processor 605. The instructions may also be downloaded into the computer platform 601 via Internet using a variety of network data communication protocols well known in the art.

The computer platform 601 also includes a communication interface, such as network interface card 613 coupled to the data bus 604. Communication interface 613 provides a two-way data communication coupling to a network link 614 that is coupled to a local network 615. For example, communication interface 613 may be an integrated services digital network (ISDN) card or a modem to provide a data communication connection to a corresponding type of telephone line. As another example, communication interface 613 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 613 sends and receives electrical, electromagnetic or optical signals that carry digital data streams representing various types of information.

Network link 613 typically provides data communication through one or more networks to other network resources. For example, network link 614 may provide a connection through local network 615 to a host computer 616, or a network storage/server 617. Additionally or alternatively, the network link 613 may connect through gateway/firewall 617 to the wide-area or global network 618, such as an Internet. Thus, the computer platform 601 can access network resources located anywhere on the Internet 618, such as a remote network storage/server 619. On the other hand, the computer platform 601 may also be accessed by clients located anywhere on the local area network 615 and/or the Internet 618. The network clients 620 and 621 may themselves be implemented based on the computer platform similar to the platform 601.

Local network 615 and the Internet 618 both use electrical, electromagnetic or optical signals that carry digital data streams. The signals through the various networks and the signals on network link 614 and through communication interface 613, which carry the digital data to and from computer platform 601, are exemplary forms of carrier waves transporting the information.

Computer platform 601 can send messages and receive data, including program code, through the variety of network(s) including Internet 618 and LAN 615, network link 614 and communication interface 613. In the Internet example, when the system 601 acts as a network server, it might transmit a requested code or data for an application program running on client(s) 620 and/or 621 through Internet 618, gateway/firewall 617, local area network 615 and communication interface 613. Similarly, it may receive code from other network resources.

The received code may be executed by processor 605 as it is received, and/or stored in persistent or volatile storage devices 608 and 606, respectively, or other non-volatile storage for later execution. In this manner, computer system 601 may obtain application code in the form of a carrier wave.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the document/directory recommendation system. It is intended that the specification and examples be considered as exemplary only, with a true scope and spirit of the invention being indicated by the following claims.

What is claimed is:

1. A system comprising:
a display;
a storage system;
an organizational table comprising organizational attributes of users of the system;
a scoring unit generating a score for a document for a requesting user by:
identifying organizational attributes of a user who previously interacted with the document;
analyzing a relationship between the organizational attributes of the user who interacted with the document and the organizational attributes of the requesting user; and
assigning a score to the document based on the analyzed relationship between the organizational attributes of the user who interacted with the document and the organizational attributes of the requesting user;
a recommendation unit recommending the document to the requesting user if the score assigned to the document exceeds a threshold value, by displaying the document to the requesting user on the display.

2. The system of claim 1, further comprising an access log recording previous access to the document.

3. The system of claim 1, wherein the score of the scored document decays over time.

4. The system of claim 2, wherein the score of the scored document decays based on a half-life calculation.

5. The system of claim 1, wherein the displaying comprises displaying the scored document on a side of the display in an icon form.

6. The system of claim 1, wherein the organizational attributes comprises a job classification.

7. A system comprising:
a display;
a storage system;
a scoring unit assigning a score to a directory; and
a recommendation unit recommending the scored directory to a user.

8. The system of claim 7, further comprising an access log recording previous activity within the directory.

9. The system of claim 7, wherein the assigned score decays over time.

10. The system of claim 7, wherein the assigned score is based on previous activity within the directory.

11. The system of claim 7, wherein the recommending comprises displaying the scored directory on a side of the display in an icon form.

12. The system of claim 7, wherein the assigned score is based on scores assigned to documents located within the directory being scored.

13. The system of claim 7, wherein the recommendation unit further recommends documents located within the recommended directory.

14. The system of claim 7, wherein unaccessed documents located within the directory are scored based on the score of the scored directory.

15. The system of claim 13, wherein recommended documents located within a displayed recommended directory are displayed upon highlighting the recommended directory.

16. A system comprising:
a display;
a storage system;
a scoring unit assigning a score to a document based on an interaction history of the document; and
a recommendation unit recommending the scored document to a user;
wherein the score of the document decays over time.

17. The system of claim 16, wherein the score is decayed based on a date of a prior document interaction.

18. The system of claim 17, wherein the decay of the score decays based on a half life calculation.

19. The system of claim 17, wherein the history of prior document interactions is recorded on an access log, and the access log discards records of access based on the date of the interaction.

20. The system of claim 16, wherein the recommending comprises displaying the scored document on a side of the display in an icon form.
